(19) United States
(12) Patent Application Publication
(10) Pub. No.: US 2018/0267440 A1
(43) Pub. Date: Sep. 20, 2018

(54) FIXING DEVICE AND IMAGE FORMING APPARATUS

(71) Applicant: FUJI XEROX CO., LTD., Tokyo (JP)

(72) Inventors: Takashi MATSUBARA, Kanagawa (JP); Tetsuro KODERA, Kanagawa (JP)

(73) Assignee: FUJI XEROX CO., LTD., Tokyo (JP)

(21) Appl. No.: 15/698,939

(22) Filed: Sep. 8, 2017

(30) Foreign Application Priority Data
Mar. 14, 2017 (JP) 2017-049120

(51) Int. Cl. G03G 15/20

(52) U.S. Cl. CPC G03G 15/2007; G03G 15/6529

(57) ABSTRACT

A fixing device includes a light source fixed to an apparatus body, a transmission member that touches a developer image on a recording medium while rotating and that allows light from the light source to pass therethrough toward the developer image, and a moving unit located on a side of the recording medium opposite to the transmission member, the moving unit increasing, when moved relative to the transmission member, an area of the recording medium over which the recording medium touches the transmission member downstream from an illumination position, at which the developer image on the recording medium is irradiated with light.

### CROSS-REFERENCE TO RELATED APPLICATIONS

This application is based on and claims priority under 35 USC 119 from Japanese Patent Application No. 2017-049120 filed Mar. 14, 2017.

### BACKGROUND

### Technical Field

The present invention relates to a fixing device and an image forming apparatus.

### SUMMARY

According to an aspect of the invention, a fixing device includes a light source fixed to an apparatus body; a transmission member that touches a developer image on a recording medium while rotating and that allows light from the light source to pass therethrough toward the developer image; and a moving unit located on a side of the recording medium opposite to the transmission member, the moving unit increasing, when moved relative to the transmission member, an area of the recording medium over which the recording medium touches the transmission member downstream from an illumination position, at which the developer image on the recording medium is irradiated with light.

### BRIEF DESCRIPTION OF THE DRAWINGS

Exemplary embodiments of the present invention will be described in detail based on the following figures, wherein:

FIG. 1 illustrates the entire configuration of an image forming apparatus according to a first exemplary embodiment;

FIG. 2 illustrates the configuration of a fixing device according to the first exemplary embodiment;

FIG. 3A illustrates a contact roller according to the first exemplary embodiment in a first position, and FIG. 3B illustrates the contact roller according to the first exemplary embodiment in a second position;

FIG. 4A is a graph showing the relationship between the toner temperature and the time elapsed after the toner according to the first exemplary embodiment is heated, and FIG. 4B is a graph showing the relationship between the glossiness of the toner image and the separation temperature at which the toner image according to the first exemplary embodiment is separated;

FIG. 5 is a flowchart of a method for switching the position of the contact roller according to the first exemplary embodiment to the first position or the second position;

FIG. 6A illustrates the fixing device according to the first exemplary embodiment when the contact roller is in the first position, and FIG. 6B illustrates the fixing device according to the first exemplary embodiment when the contact roller is in the second position;

FIG. 7 is a graph showing the relationship between the glossiness of various media according to the first exemplary embodiment and the glossiness of an image fixed to each medium;

FIG. 8 illustrates the structure of the fixing device according to a second exemplary embodiment;

FIG. 9 illustrates the structure of a moving portion that moves a pressing roller according to the second exemplary embodiment;

FIG. 10 illustrates a nip portion when the pressing roller according to the second exemplary embodiment is moved to a different position;

FIG. 11 illustrates the structure of a fixing device according to a third exemplary embodiment;

FIG. 12A illustrates a contact roller according to the third exemplary embodiment in the first position, FIG. 12B illustrates the contact roller according to the third exemplary embodiment in the second position, and FIG. 12C illustrates the contact roller according to the third exemplary embodiment in the third position;

FIG. 13A illustrates a contact roller according to a first modification example in the first position, FIG. 13B illustrates the contact roller according to the first modification example in the second position, and FIG. 13C illustrates the contact roller according to the first modification example in the third position;

FIG. 14 illustrates part of a fixing device according to a second modification example; and

FIG. 15 illustrates part of the fixing device according to a third modification example.

### DETAILED DESCRIPTION

### First Exemplary Embodiment

A fixing device and an image forming apparatus according to a first exemplary embodiment are described by way of example.

### Entire Structure

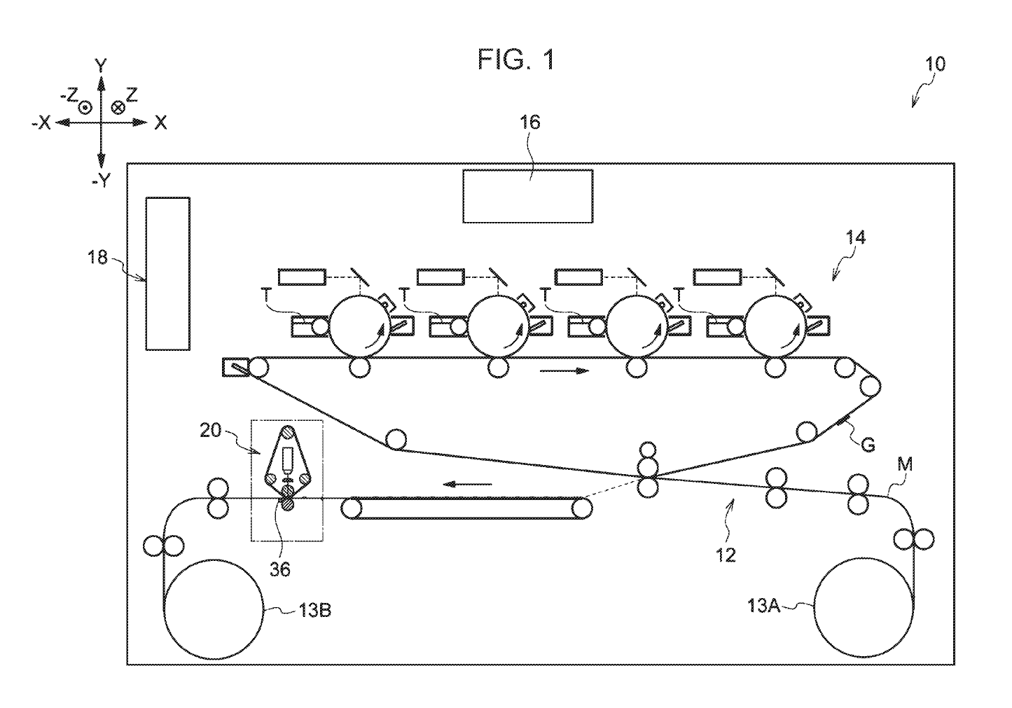

FIG. 1 illustrates an image forming apparatus 10 according to a first exemplary embodiment. The image forming apparatus 10 includes, for example, a transportation unit 12, an image forming unit 14, a control panel 16, a controller 18, and a fixing device 20. The transportation unit 12 transports a medium M toward the fixing device 20. The image forming unit 14 forms a toner image G on the medium M transported by the transportation unit 12 using toner T. Although described in detail below, the fixing device 20 fixes the toner image G formed by the image forming unit 14 onto the medium M. Although described in detail below, the controller 18 controls the operation of each unit of the image forming apparatus 10.

The medium M is an example of a recording medium and includes a sheet and a film. The medium M according to the first exemplary embodiment is a continuous form by way of example. The medium M has a length at least extending from a let-off roller 13A of the transportation unit 12 to a take-up roller 13B of the transportation unit 12. The toner T is an example of a developer. The toner image G is an example of a developer image. The image forming unit 14 is an example of a forming unit. The controller 18 is an example of a controlling unit. The image forming unit 14 performs charging, exposure, development, transfer, and cleaning.

In the following description, the direction of arrow Y in FIG. 1 refers to the direction of the height of the image forming apparatus 10, and the direction of arrow X in FIG. 1 refers to the direction of the width of the image forming apparatus 10. The direction (denoted by Z) perpendicular to the height direction and the width direction refers to the direction of the depth of the image forming apparatus 10. When the image forming apparatus 10 is viewed from the side of a user, not illustrated, (viewed from the front), the width direction, the height direction, and the depth direction respectively refer to direction X, direction Y, and direction Z. To distinguish between one side and the other side of each of direction X, and direction Y, and direction Z, the upper side is referred to as side Y, the lower side is referred to as side −Y, the right side is referred to as side X, the left side is referred to as side −X, the far side (back side) is referred to as side Z, and the near side is referred to as side −Z, when the image forming apparatus 10 is viewed from the front.

### Control Panel

The control panel 16 is a touch panel, serving as an example of an information setting unit. The control panel 16 displays, for example, various information on the image forming apparatus 10 and select buttons selectable by users. The control panel 16 allows users to set the glossiness of toner images G (images) to be formed by the image forming apparatus 10, the types of the medium M, and the imaging process speed (corresponding to the number of sheets on which images are formed per unit time). The glossiness here complies with the definitions described in JIS 28741. The glossiness is measured by, for example, a specular glossmeter Model 503 (from Erichsen) under the conditions of the incidence angle of 60 degrees and the reception angle of 60 degrees.

The control panel 16 allows users to select, for example, high glossiness or low glossiness, the types (materials) of the medium M between sheets and films, and the imaging process speed between the low speed and the high speed. Various information selected (set) through the control panel 16 is transmitted to the controller 18, described below.

### Structure of Related Portions

The fixing device 20 and the controller 18 are described now.

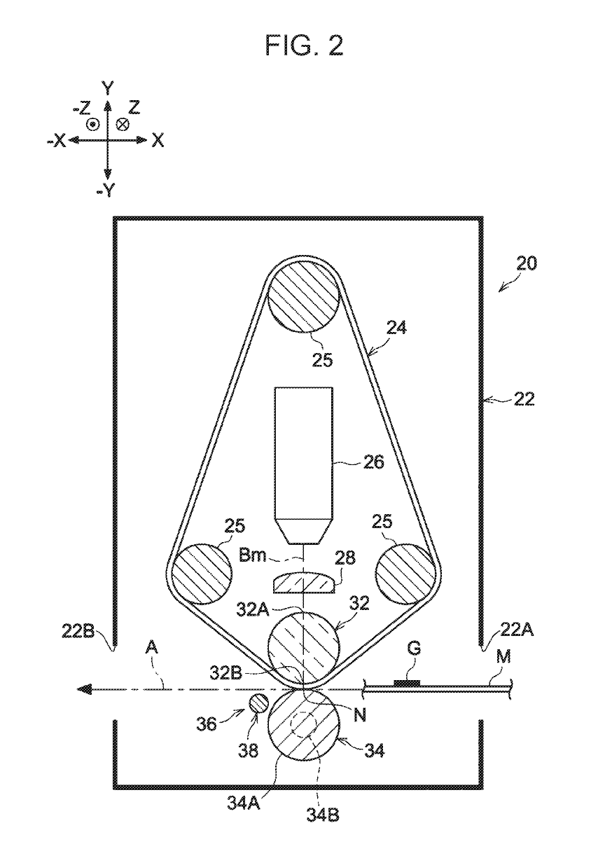

As illustrated in FIG. 2, the fixing device 20 includes, for example, a housing 22, a transparent belt 24, a light source 26, a condensing lens 28, a transparent roller 32, a pressing roller 34, and a moving portion 36. The housing 22 is an example of the apparatus body. The transparent belt 24 is an example of a transmission member. The transparent roller 32 is an example of a contact member. The pressing roller 34 is an example of a pressing member. The moving portion 36 is an example of a moving unit.

### Housing

The housing 22 is formed from a heat-resistant resin material in a cuboid shape whose longitudinal direction extends in direction Z. The housing 22 has an inlet port 22A, allowing the medium M to enter the housing 22 therethrough, and an outlet port 22B, allowing the medium M to be discharged from the housing 22 therethrough. For example, the inlet port 22A and the outlet port 22B are arranged in direction X.

### Transparent Belt

The transparent belt 24 is endless. The transparent belt 24 is stretched around, for example, three guide rollers 25, whose axes extend in direction Z, and the transparent roller 32. The transparent belt 24 is rotated (rotationally moved) as a result of the guide rollers 25 being rotated by being driven to rotate by a gear or motor, not illustrated. The transparent belt 24 allows a laser beam Bm from the light source 26 to pass therethrough at a nip portion N pressed by the pressing roller 34. The light source 26 and the nip portion N are described below.

The transparent belt 24 touches the toner image G on the medium M at the nip portion N. At the nip portion N, the toner image G is heated by the laser beam Bm and pressed to be fixed onto the medium M. The transparent belt 24 touches the toner image G on the medium M while rotating and allows the laser beams Bm from the light source 26 to pass therethrough toward the toner image G.

The transparent belt 24 has, for example, a four-layer structure including an elastic layer, a base layer laminated on the elastic layer, an intermediate layer laminated on the base layer, and a separation layer laminated on the intermediate layer. A primer layer for enhancing adhesiveness is disposed between each adjacent pair of the elastic layer, the base layer, the intermediate layer, and the separation layer.

The elastic layer is an innermost layer of the transparent belt 24, located closest to the transparent roller 32 (located innermost) and exposed to the outside. The elastic layer is formed from, for example, silicone rubber having a greater thickness than the base layer and allows the laser beams Bm to pass therethrough. The “elastic layer” in this exemplary embodiment refers to a layer that is elastically deformed in a thickness direction to a greater extent than the base layer when pressed at the nip portion N. Examples of the material other than silicone rubber include chloroprene rubber, butyl rubber, acrylic rubber, polyurethane rubber, nitrile rubber, fluoro rubber, and styrene-butadiene rubber.

The base layer is a layer for retaining sufficient strength for the transparent belt 24. The base layer is formed from, for example, polyimide and allows the laser beams Bm to pass therethrough. Usable examples other than polyimide include polyvinylidene fluoride (PVDF), polyethylene (PE), polyurethane (PU), polydimethylsiloxane (PDMS), polyetheretherketone (PEEK), polyether sulfone (PES), fluorinated ethylene propylene (FEP), ethylene tetrafluoroethylene copolymer (ETFE), chlorotrifluoroethylene (CTFE), polyvinylidene fluoride (PVDF), polyvinyl fluoride (PVF), and polytetrafluoroethylene (PTFE). The base layer may be formed from any combination of these materials.

The intermediate layer is formed from, for example, silicone rubber and allows the laser beams Bm to pass therethrough. In this exemplary embodiment, for example, the elastic layer and the intermediate layer are formed from the same material (silicone rubber).

The separation layer is formed from, for example, tetrafluoroethylene perfluoroalkoxy ethylene copolymer (PFA) and allows the laser beams Bm to pass therethrough. The separation layer further reduces adhesion of the toner image G to the transparent belt 24 than the structure excluding the separation layer. Other examples of the material forming the separation layer include polytetrafluoroethylene (PTFE), tetrafluoroethylene hexafluoropropylene copolymer (FEP), and ethylene-tetrafluoroethylene copolymer (ETFE). The separation layer provides appropriate gloss to the fixed toner image G together in cooperation with the intermediate layer.

### Light Source

The light source 26 is located on the inner side of the transparent belt 24 and fixed to the housing 22 using a bracket, not illustrated. The light source 26 includes, for example, multiple laser arrays and a collimating lens, which are not illustrated. The multiple laser arrays emit laser beams Bm in direction Z and toward side −Y. The collimating lens collimates the laser beams Bm emitted from the laser arrays. The laser beams Bm are an example of light. The light source 26 causes the laser beams Bm to be incident on the condensing lens 28, described below. The laser beams Bm condensed by the condensing lens 28 pass through the transparent roller 32 and the transparent belt 24, which are described below, to illuminate the toner image G.

In this exemplary embodiment, for example, the longitudinal direction of the light source 26 is direction Z, the direction in which the laser beam Bm illuminates the toner image G is direction Y, and the direction perpendicular to direction Z and direction Y and in which the medium M is transported is direction X. The medium M is transported, for example, from side X to side −X.

### Condensing Lens

The condensing lens 28 is positioned on the optical axis of the laser beam Bm between the light source 26 and the transparent roller 32, described below. The condensing lens 28 is formed from a plano-convex lens that condenses the laser beams Bm emitted from the light source 26 to the nip portion N, described below.

### Transparent Roller

The transparent roller 32 is located on the inner side of the transparent belt 24 and on side Y of the transportation path A, along which the medium M is transported, so as to be rotatable around the axis extending in direction Z. The transparent roller 32 is in contact with the inner peripheral surface of the transparent belt 24 at an illumination position illuminated by the laser beam Bm. The transparent roller 32 is an optical member that allows the laser beams Bm from the light source 26 to pass therethrough and that condenses the light beams Bm to the nip portion N, described below. An example of the transparent roller 32 is a glass roller, which is a columnar (solid) rod lens. The optical axis of each laser beam Bm passes through the center of the transparent roller 32 when the transparent roller 32 is viewed in direction Z.

A portion of the outer peripheral surface of the transparent roller 32 on which the laser beams Bm are incident is referred to as an incident point 32A. The incident point 32A is an area (portion) including the top of the transparent roller 32 in direction Y when the transparent roller 32 is viewed in direction Z. On the other hand, a portion of the outer peripheral surface of the transparent roller 32 that is 180 degrees from the incident point 32A is referred to as a pressing point 32B. The pressing point 32B is a portion of the outer peripheral surface of the transparent roller 32 that touches the inner peripheral surface of the transparent belt 24.

The transparent belt 24 and the transparent roller 32 being “transparent” in this exemplary embodiment represents the transparent belt 24 and the transparent roller 32 having sufficiently high transmittance in the wavelength range of the laser beams Bm. Specifically, the transparent belt 24 and the transparent roller 32 may be formed from any members that allow the laser beams Bm to pass therethrough. From the optical efficiency view point, higher transmittance is more preferable. For example, the transmittance is or exceeds 90%, or desirably, is or exceeds 95%.

### Pressing Roller

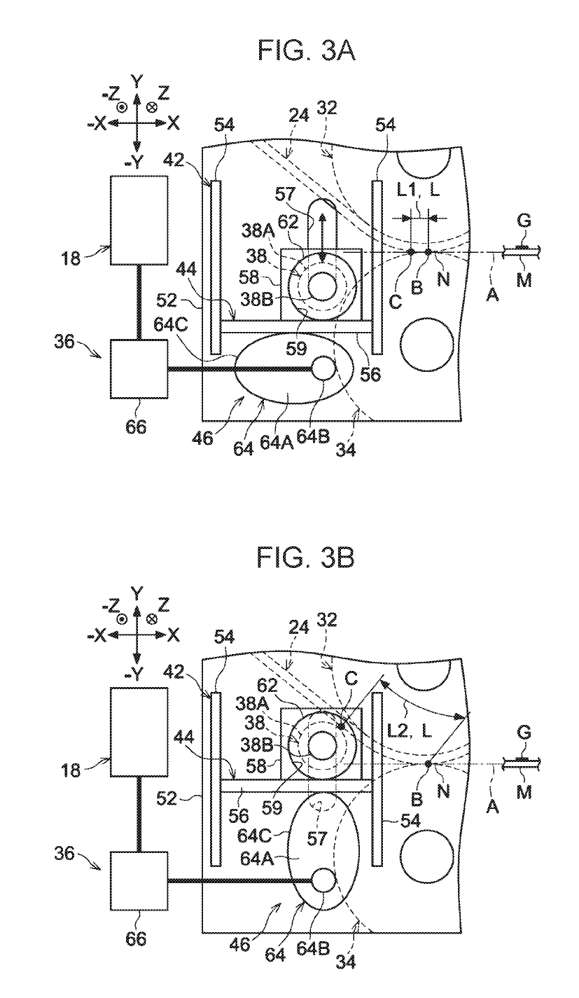

The pressing roller 34 includes, for example, a columnar body 34A made of stainless steel, and a columnar shaft 34B protruding from both ends of the body 34A outward in the axial direction and having a smaller diameter than the body 34A. The pressing roller 34 is located on side −Y of the transportation path A, along which the medium M is transported, so as to be rotatable around its axis extending in direction Z. The pressing roller 34 is so positioned as to exert a predetermined pressing force between itself and the transparent belt 24. In other words, the pressing roller 34 holds the medium M on which the toner image G is formed between itself and the transparent belt 24 at the illumination position B (refer to FIG. 3A), described below, and transports the medium M to side −X.

The portion (area) at which the transparent roller 32 and the pressing roller 34 hold the transparent belt 24 and the medium M therebetween and at which the toner image G is pressed is referred to as a nip portion N. Specifically, the pressing roller 34 presses the toner image G on the medium M and the transparent belt 24 against the transparent roller 32 to form the nip portion N. Also at the nip portion N, the toner image G on the medium M is heated by the laser beams Bm.

### Moving Portion

The moving portion 36 illustrated in FIG. 3A is located on the side of the medium M (transportation path A) opposite to the transparent belt 24. The moving portion 36 includes a contact roller 38, which is an example of a moving member, a support portion 44, which supports the contact roller 38 so that the contact roller 38 is rotatable, a guide portion 42, which guides the support portion 44 in direction Y, and a driving portion 46, which moves the support portion 44 in direction Y. When the moving portion 36 is in a reference state, described below, the moving portion 36 moves the contact roller 38 relative to the transparent belt 24 so that the medium M touches the transparent belt 24 over a larger area downstream from the illumination position B, described below.

### Contact Roller

The contact roller 38 includes, for example, a columnar body 38A made of stainless steel and a columnar shaft 38B protruding from both ends of the body 38A outward in the axial direction and having a smaller diameter than the body 38A. When in the reference state described below, the contact roller 38 is located on side −Y of a transportation path A and downstream from the pressing roller 34 in the movement direction (transportation direction) of the medium M so as to be rotatable (driven to rotate) around its axis extending in direction Z.

Specifically, the contact roller 38 is rotatably supported by the support portion 44 so as to be movable in direction Y relative to the transparent belt 24. To increase the area of the medium M over which it touches the transparent belt 24, the contact roller 38 having this structure comes into contact with the surface of the medium M opposite to the surface carrying the toner image G and rotates while holding the medium M between itself and the transparent belt 24. In other words, the contact roller 38 holds the transparent belt 24 between itself and the transparent roller 32 while in a moving state, described below.

The position of the contact roller 38 when the shaft 38B is located on side −Y of the transportation path A and the body 38A touches the surface of the medium M on side −Y is referred to as a first position. The state where the contact roller 38 is in the first position is referred to as a reference state. Here, when the nip portion N is viewed in direction Z, the point in the nip portion N at which the laser beams Bm (refer to FIG. 2) illuminate the toner image G on the medium M is referred to as an illumination position B. The point at which the medium M separates from the transparent belt 24 is referred to as a separation position C. The length of the outer peripheral surface of the transparent belt 24 from the illumination position B to the separation position C is referred to as a path length L. The path length L corresponds to an area over which the medium M touches the transparent belt 24 downstream from the illumination position B in the transportation direction of the medium M. The path length L being longer than the path length L in the reference state is referred to as an increase of the area over which the medium M touches the transparent belt 24 downstream from the illumination position B.

When the nip portion N is viewed in direction Z, the illumination position B according to this exemplary embodiment is located substantially the middle of the nip portion N in direction X. In the reference state, the contact roller 38 is located on side −Y of the transportation path A. The separation position C is located in the nip portion N at a point at which the medium M is separates from the transparent belt 24. The path length L in the reference state is referred to as a path length L1.

As illustrated in FIG. 3B, the position of the contact roller 38 when the shaft 38B is located on side Y of the transportation path A and the medium M is held between the outer peripheral surface of the body 38A and the transparent belt 24 is referred to as a second position. The state where the contact roller 38 is in the second position is referred to as a moving state. In the moving state, the contact roller 38 is located on side Y of the transportation path A. The separation position C in the moving state is located downstream from the nip portion N in the movement direction of the transparent belt 24 and at which the medium M held between the transparent belt 24 and the contact roller 38 separates from the outer peripheral surface of the transparent belt 24. The path length L in the moving state is referred to as a path length L2. The path length L2 is longer than the path length L1 (refer to FIG. 3A). Although not illustrated, at the separation position C during the moving state and transportation of the medium M, the transparent belt 24 is supported by the transparent roller 32.

### Guide Portion

The guide portion 42 includes, for example, side plates 52 and a pair of rails 54. The side plates 52 stand erect along a x-y plane from the bottom of the housing 22 (refer to FIG. 2) to side Y on both outer sides, in direction Z, of the transparent belt 24, the transparent roller 32, the pressing roller 34, and the contact roller 38. Each side plate 52 is provided with a bearing, not illustrated, which supports the transparent roller 32 and the pressing roller 34 so that the transparent roller 32 and the pressing roller 34 are rotatable.

Each side plate 52 has a guide hole 57, which extends through the side plate 52 in direction Z and is long in direction Y. The shaft 38B of the contact roller 38 is inserted in the guide hole 57. When the shaft 38B touches the hole wall of the guide hole 57, the shaft 38B is guided in direction Y. The pair of rails 54 are located on side X and side −X of the guide holes 57, in the outer side surfaces of both side plates 52 in direction Z. The pair of rails 54 extend in direction Y. A guidable plate 56, described below, is located between the pair of rails 54.

### Support Portion

The support portion 44 includes, for example, a guidable plate 56, support plates 58, and bearings 62. The guidable plate 56 is rectangular and located between the pair of rails 54 while having its thickness direction extending in direction Y and its longitudinal direction extending in direction X. Both ends of the guidable plate 56 in direction X are in contact with the inner side surfaces of the pair of rails 54. Thus, the guidable plate 56 is guided in direction Y along the pair of rails 54.

The support plates 58 stand erect along the x-y plane on an upper surface of the guidable plate 56 on side Y. The support plates 58 are located on the outer sides of both side plates 52 in direction Z and face the side plates 52 in direction Z. Each support plate 58 has a through hole 59 extending through the support plate 58 in direction Z. Each bearing 62 is fitted into the corresponding through hole 59, open in direction Z (having its axis in direction Z).

The shaft 38B is inserted into the bearing 62 so as to be rotatable around its axis. The guidable plates 56, the support plates 58, and the bearings 62 are integrally moved (guided) in direction Y, so that the contact roller 38 is moved in direction Y while being rotatably supported. In other words, the support portion 44 moves the contact roller 38 between the first position and the second position while supporting the contact roller 38 so that the contact roller 38 is rotatable.

### Driving Portion

The driving portion 46 includes, for example, a cam member 64 and a motor 66. The cam member 64 includes an elliptic cam body 64A, whose thickness extends in direction Z, and a shaft 64B, protruding from the cam body 64A in direction Z. The shaft 64B is supported by a bearing, not illustrated, provided at each side plate 52 so as to be rotatable around its axis extending in direction Z. Part of an outer peripheral surface 64C of the cam member 64 is in contact with the surface of the guidable plate 56 on side −Y. Thus, the contact roller 38 is in the first position when the cam member 64 has its major axis extend in direction X, and the contact roller 38 is in the second position when the cam member 64 has its major axis extend in direction Y. A motor 66 is connected to the shaft 64B using a gear, not illustrated.

The motor 66 is driven by the controller 18. Specifically, to move the contact roller 38 from the first position to the second position, the motor 66 rotates the cam member 64 so that the cam member 64 has its major axis extend in direction Y. To move the contact roller 38 from the second position to the first position, the motor 66 rotates the cam member 64 so that the cam member 64 has its major axis extend in direction X. The rotation position of the cam member 64 is detected by a sensor, not illustrated. The information on the detected rotation position of the cam member 64 is transmitted to the controller 18.

### Controller

The controller 18 illustrated in FIG. 1 includes a central processing unit (CPU), a read only memory (ROM), a random access memory (RAM), a storage unit, a telecommunication line interface (I/F), and a bus, which are not illustrated.

The CPU is an example of a computer and controls the entire operation of each unit of the image forming apparatus 10 and the operation of the fixing device 20. Various programs or various parameters are stored in advance in the ROM. Various programs include an operation program of the driving portion 46 (refer to FIG. 3A). The RAM is used as a work area for the CPU to execute the various programs. The storage unit is a nonvolatile storage unit such as a flash memory. The telecommunication line I/F transmits or receives communication data to or from external devices. The bus electrically connects the components included in the controller 18 to one another.

The controller 18 acquires, from the control panel 16, information on the users' intended glossiness (image glossiness) of the toner image G (image), the users' intended type of the medium M, and the users' intended process speed. The controller 18 controls movement of the moving portion 36 (contact roller 38) so that the medium M touches the transparent belt 24 over a wider area downstream from the illumination position B than when the fixed toner image G is to have low glossiness or when the medium M is to move at a low speed.

Specifically, the controller 18 has a program for changing the position of the contact roller 38 to the second position to increase the above-described path length L (refer to FIG. 3A) further than in the case of the reference state. The controller 18 also has a program for changing the position of the contact roller 38 to decrease the above-described path length L further than in the case of the moving state.

The controller 18 changes the position of the contact roller 38 to the second position when, for example, receiving at least one of information that the toner image G is to have high glossiness, information that the medium M is a film, and information that the medium M is to move at a high movement speed (process speed). The controller 18 changes the position of the contact roller 38 to the first position when, for example, receiving all the information that the toner image G is to have low glossiness, information that the medium M is a sheet, and information that the medium M is to move at a low process speed. Here, the controller 18 does not change the position of the contact roller 38 when the contact roller 38 is already in the intended position.

### Relationship Between Separation Temperature and Glossiness

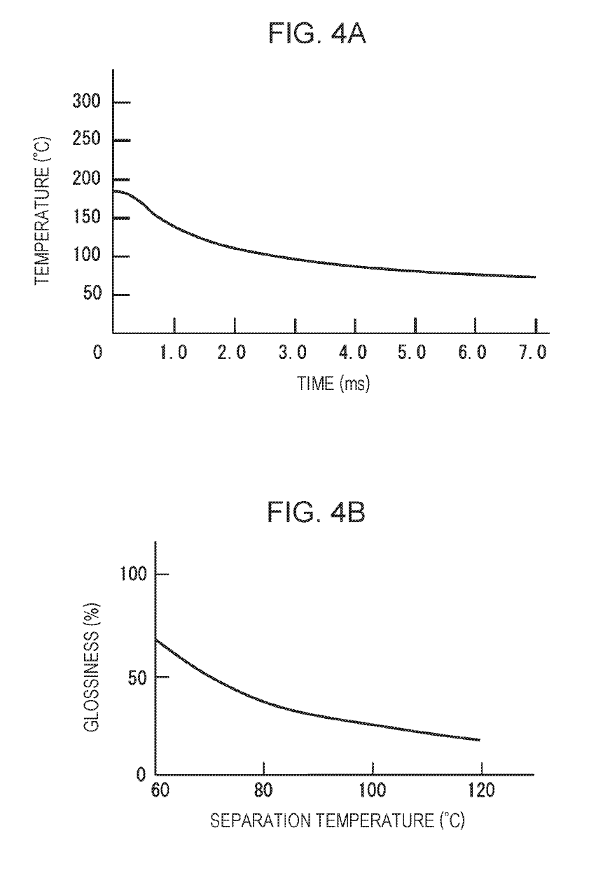

As illustrated in FIG. 4A, a graph plotted using the time (time elapsed after the toner T is heated) on the horizontal axis and the temperature (temperature of the toner T) on the vertical axis shows that the temperature of the toner T decreases with an elapse of time. As illustrated in FIG. 4B, a graph plotted using the separation temperature of the toner image G, when the transparent belt 24 (refer to FIG. 2) is separated from the medium M, on the horizontal axis and the glossiness of the toner image G on the vertical axis shows that the glossiness increases with a decrease of the separation temperature. Specifically, after the fixing device 20 in FIG. 2 fixes the toner image G onto the medium M, the obtained toner image G (image) has higher glossiness as the toner image G is cooled for a longer period by increasing the above-described path length L (refer to FIG. 3B).

### Comparative Example

In comparison with the fixing device 20 (refer to FIG. 2), a fixing device according to a comparative example has a structure in which the illumination position B is changed by changing the position of the light source 26 (refer to FIG. 2) to change the path length L from the illumination position B to the separation position C (refer to FIG. 3A). The fixing device according to the comparative example is not illustrated. In the fixing device according to the comparative example, the position of the light source 26 is changed, so that the incident angle of the laser beam Bm on the transparent belt 24 is changed. Thus, the light energy applied to the toner image G may be reduced compared to the case where the position of the light source 26 is unchanged. In this structure, the toner image G may melt insufficiently and the fixed toner image G (image) may have low glossiness.

### Operation

The operation of the first exemplary embodiment is described now.

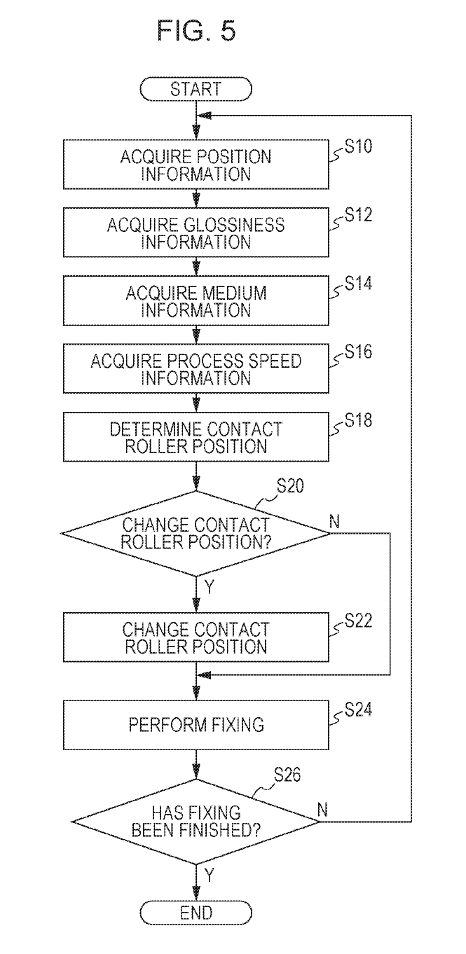

The image forming apparatus 10 shown in FIG. 1 executes a program for changing the path length, illustrated in FIG. 5. The components or portions included in the image forming apparatus 10 are to be referred to FIGS. 1, 2, 3A, and 3B.

In step S10 in FIG. 5, the controller 18 acquires the position information of the cam member 64 from a sensor, not illustrated, to acquire the position information (first or second position) of the contact roller 38. Here, the controller 18 acquires the position information that, for example, the contact roller 38 is in the first position, as illustrated in FIG. 2. The processing then moves to step S12 in FIG. 5.

In step S12, the controller 18 acquires the glossiness information from the control panel 16. Here, for example, the intended glossiness information is assumed to be glossiness higher than reference glossiness. The processing then moves to step S14.

In step S14, the controller 18 acquires the medium information from the control panel 16. Here, for example, the medium information is assumed to be a sheet (ordinary sheet). The processing then moves to step S16.

In step S16, the controller 18 acquires the process speed information from the control panel 16. Here, for example, the process speed information is assumed to be a high speed. The processing then moves to step S18.

In step S18, the controller 18 determines the position of the contact roller 38 on the basis of the glossiness information, the medium information, and the process speed information. Here, for example, the contact roller 38 is determined to be moved to the second position on the basis of the glossiness information. The processing then moves to step S20.

In step S20, the controller 18 compares the position information of the contact roller 38 acquired in step S10 with the position information of the contact roller 38 determined in step S18. When these position information pieces fail to coincide with each other, the processing moves to step S22. When these position information pieces coincide with each other, the processing moves to step S24.

In step S22, the controller 18 drives the driving portion 46 to move the contact roller 38 to the position determined in step S18 (to change the position of the contact roller 38). Here, for example, the position of the contact roller 38 is changed from the first position to the second position. The processing then moves to step S24.

In step S24, the controller 18 rotates the transparent belt 24 to introduce the toner image G into the nip portion N and causes the light source 26 to emit the laser beam Bm to the toner image G. Thus, in the nip portion N, the toner image G is heated (melted) and pressed to be fixed onto the medium M. The processing then moves to step S26.

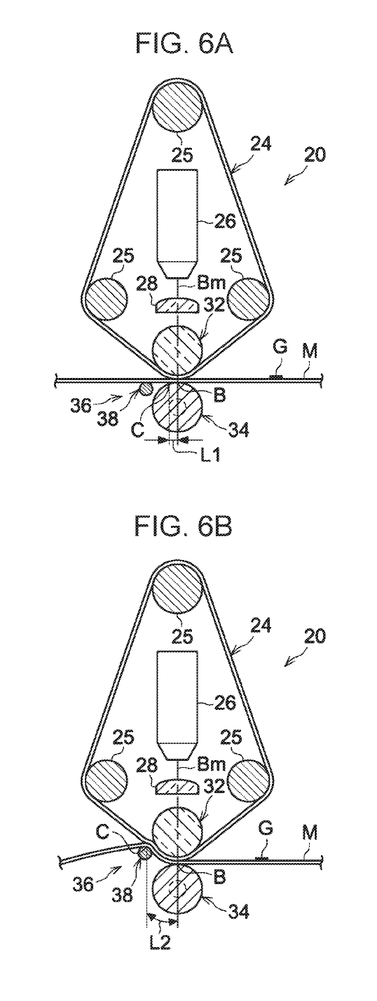

As illustrated in FIG. 6B, when the contact roller 38 is positioned in the second position, the path length L2 from the illumination position B to the separation position C is increased further than the path length L1 (refer to FIG. 6A). Thus, during the period from when the toner image G starts being heated at the illumination position B to when the toner image G arrives at the separation position C, the temperature of the toner image G touching the transparent belt 24 decreases to approximately the glass transition temperature of the toner T (the toner image G hardens). Thus, the toner image G is less likely to have a roughened surface when the medium M and the toner image G are separated (detached) from the transparent belt 24. This structure thus forms an image having higher glossiness than an image formed by the above-described comparative example.

In step S26 illustrated in FIG. 5, the controller 18 calculates the difference between the number of the media M on which an image is formed set through the control panel 16 and the number of the media M subjected to fixing in step S24. When the calculated difference is zero, the controller 18 finishes the program. When, on the other hand, the calculated difference is one or more, the processing moves back to step S10 and the controller 18 repeats the above steps until the difference arrives at zero.

Assume a case where the controller 18 determines in step S18 that the contact roller 38 is supposed to be in the first position. In this case, the path length L1 illustrated in FIG. 6A is shorter than the path length L2 (refer to FIG. 6B). Thus, the toner image G is more likely to have a roughened surface when the medium M and the toner image G are separated (detached) from the transparent belt 24 and the image has low glossiness.

As described above, in the fixing device 20 illustrated in FIG. 2, the light source 26 is fixed to the housing 22. In this structure, the illumination position B is negligibly changed unlike in the above-described comparative example in which the position of the light source 26 is changed. This structure thus prevents shortage of the amount of light energy fed to fix the toner image G. In the fixing device 20, the moving portion 36 is capable of changing the path length L from the illumination position B to the separation position C. The fixing device 20 increases the path length L to acquire an image having high glossiness, and the fixing device 20 reduces the path length L to acquire an image having low glossiness. Thus, the image is allowed to have intended glossiness. In other words, the fixing device 20 enhances the glossiness of the fixed image compared to the comparative example.

In the fixing device 20, the pressing roller 34 and the contact roller 38 are separately provided. The fixing device 20 having this structure is capable of increasing the path length L from the illumination position B to the separation position C unlike in the structure where the contact roller 38 and the pressing roller 34 are integrated as a common unit. In other words, the medium M touches the transparent belt 24 over a greater area. This structure extends the cooling time of the toner image G.

In the fixing device 20, the transparent roller 32 touches the inner side of the transparent belt 24. Thus, the heat transmitted from the toner image G to the transparent belt 24 during heating of the toner image G is transmitted to the transparent roller 32. This structure thus enhances heat transfer from the transparent belt 24 compared to the structure excluding the transparent roller 32, and thus facilitates cooling of the toner image G.

The image forming apparatus 10 illustrated in FIG. 1 is capable of forming an image having higher glossiness than the structure including the fixing device according to the above comparative example. In other words, the image forming apparatus 10 reduces defects of the fixed image (glossiness degradation).

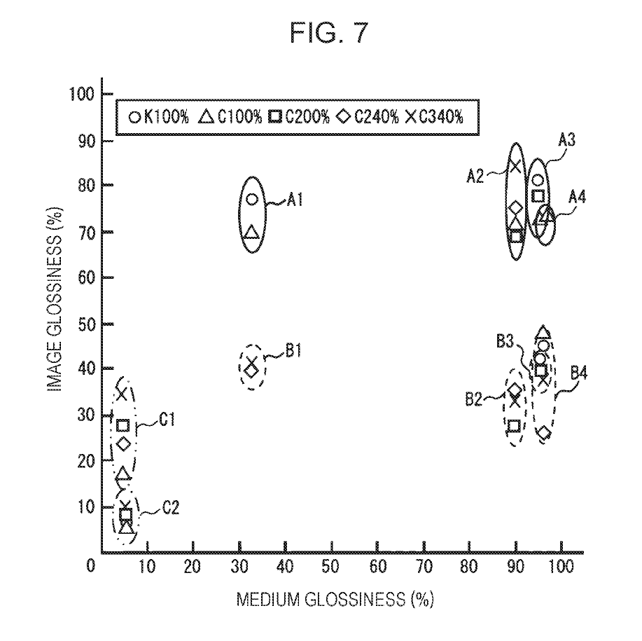

FIG. 7 shows the relationship between the glossiness (medium glossiness) of various types of media M (refer to FIG. 1) and the glossiness (image glossiness) of the toner image G fixed onto the medium M. The fixing is performed under the conditions of the process speed of 660 mm/s, the irradiation energy of the laser beams Bm of 1.7 J/cm², and the width of the nip portion N in the transportation direction of the medium M of 4 mm. The images used here include single black images (K100%) and multi-color images (C100%, C200%, C240%, and C340%, where C100% corresponds to 3.7 g/m² in toner amount per unit area). In FIG. 7, for the purposes of differentiation, the reference sign A is appended to the results obtained when the contact roller 38 (refer to FIG. 2) is in the second position, and the reference sign B is appended to the results obtained when the contact roller 38 is in the first position. For the purposes of differentiation, the reference sign C1 is appended to the results obtained when the contact roller 38 is in the first position and the media M are standard sheets, and the reference sign C2 is appended to the results obtained when the contact roller 38 is in the first position and the media M are embossed sheets.

Furthermore, for the purposes of differentiation, for the results to which the reference sign A or B is appended, the reference sign 1 is appended to the results obtained when the media M are OSC sheets from Fuji Xerox, the reference sign 2 is appended to the results obtained when the media M are polyethylene terephthalate (PET) sheets having a thickness of 12 μm, and the reference sign 3 is appended to the results obtained when the media M are PET sheets having a thickness of 50 μm. In addition, for the purposes of differentiation, the reference sign 4 is appended to the results obtained when the media M are oriented polypropylene (OPP) sheets having a thickness of 25 μm. For example, the reference sign A1 denotes a result obtained when the contact roller 38 is in the second position and the media M are OSC sheets from Fuji Xerox.

FIG. 7 shows that the results denoted with the reference sign A have higher image glossiness than those denoted with the reference sign B or C. Specifically, as the path length L (refer to FIG. 3A) increases, the glossiness (image glossiness) increases. In the cases where the media M are PET sheets having a thickness of 12 μm, PET sheets having a thickness of 50 μm, and OPP sheets having a thickness of 25 μm (reference signs A2, A3, and A4), the difference between the medium glossiness and the image glossiness is smaller than that in the case where the media M are OSC sheets from Fuji Xerox (reference sign A1).

### Second Exemplary Embodiment

Now, a fixing device and an image forming apparatus according to a second exemplary embodiment are described by way of example. Components and portions basically the same as those in the first exemplary embodiment are denoted with the same reference signs as those in the first exemplary embodiment and are not described.

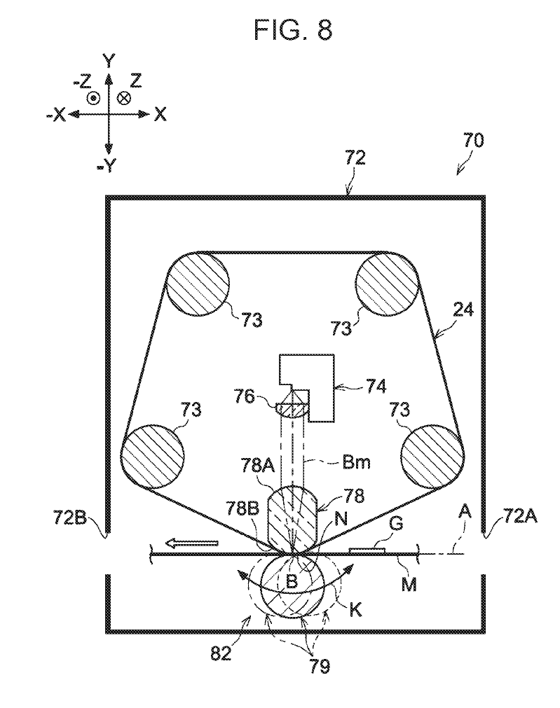

FIG. 8 illustrates a fixing device 70 according to the second exemplary embodiment. The fixing device 70 replaces the fixing device 20 (refer to FIG. 1) in the image forming apparatus 10 (refer to FIG. 1). The fixing device 70 includes, for example, a housing 72, a transparent belt 24, a light source 74, a collimating lens 76, a lens pad 78, a pressing roller 79, and a moving portion 82. The housing 72 is an example of an apparatus body. The lens pad 78 is an example of a contact member. The pressing roller 79 is an example of a changing member. The moving portion 82 is an example of a moving unit.

### Housing and Transparent Belt

The housing 72 is formed from a heat-resistant resin material and has a cuboid shape whose longitudinal direction extends in direction Z. The housing 72 has an inlet port 72A, allowing the medium M to enter the housing 72 therethrough, and an outlet port 72B, allowing the medium M to be discharged from the housing 72 therethrough. For example, the inlet port 72A and the outlet port 72B are arranged in direction X. The transparent belt 24 is stretched around, for example, four support rollers 73, whose axes extend in direction Z, and a lens pad 78, described below.

### Light Source and Collimating Lens

The light source 74 and the collimating lens 76 are disposed on the inner side of the transparent belt 24 and fixed to the housing 72 using brackets, not illustrated. The light source 74 includes, for example, multiple laser arrays, not illustrated. The multiple laser arrays emit laser beams Bm in direction Z and toward side −Y. The light source 74 causes the laser beams Bm to be incident on the collimating lens 76. The laser beams Bm collimated by the collimating lens 76 pass through the lens pad 78, described below, and the transparent belt 24 to illuminate the toner image G.

In this exemplary embodiment, for example, the longitudinal direction of the light source 74 is direction Z, the direction in which the laser beams Bm illuminate the toner image G is direction Y, and the direction perpendicular to direction Z and direction Y and in which the medium M is transported is direction X. The medium M is transported, for example, from side X to side −X.

### Lens Pad

The lens pad 78 is disposed on the inner side of the transparent belt 24 and on side Y of the transportation path A, along which the medium M is transported, while having its longitudinal direction extend in direction Z. The lens pad 78 is fixed to the housing 72 using a bracket, not illustrated. The lens pad 78 is a transparent member having an incident surface 78A on side Y and an emerging surface 78B on side −Y. The incident surface 78A curves out toward side Y when viewed in direction Z and receives the laser beams Bm. The emerging surface 78B curves out toward side −Y when viewed in direction Z. The emerging surface 78B is in contact with the inner peripheral surface of the transparent belt 24 and allows the laser beams Bm to be emitted therefrom.

The lens pad 78 is an optical member that allows the laser beams Bm incident thereon through the collimating lens 76 to pass therethrough and condenses the laser beams Bm to the illumination position B of the nip portion N, described below. The lens pad 78 being “transparent” here has the same meaning as the transparent belt 24 being “transparent”, and is thus not described here.

### Moving Portion

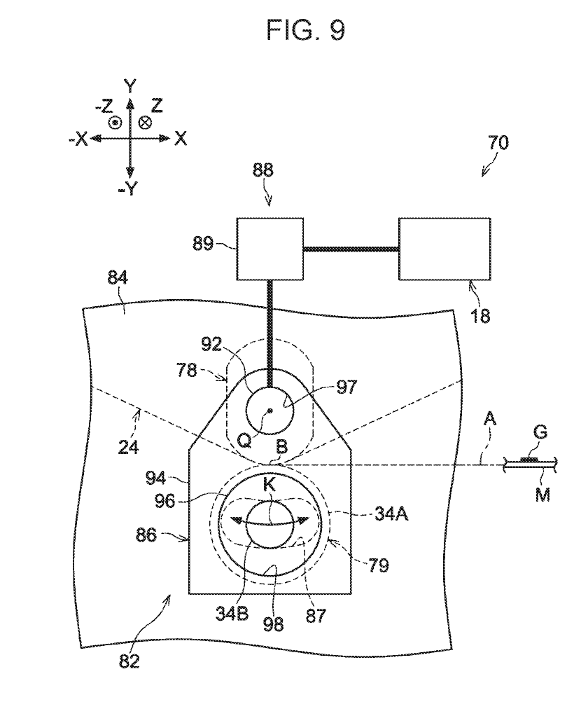

The moving portion 82 illustrated in FIG. 9 is disposed on the side of the medium M (transportation path A) opposite to the transparent belt 24. The moving portion 82 includes a pressing roller 79, which is an example of a changing member, side plates 84, a support portion 86, which supports the pressing roller 79 and which is arcuately movable with respect to the side plates 84, and a driving portion 88, which moves the support portion 86. In the reference state, the moving portion 82 moves the pressing roller 79 relative to the transparent belt 24 to change the area over which the medium M touches the transparent belt 24 downstream from the illumination position B.

### Pressing Roller

The pressing roller 79 has, for example, a structure similar to that of the pressing roller 34 (refer to FIG. 2) and includes a body 34A and a shaft 34B. The pressing roller 79 holds the medium M between itself and the transparent belt 24 at the illumination position B. The pressing roller 79 is moved upstream or downstream from the illumination position B in a movement direction of the medium M to change the area over which the medium M touches the transparent belt 24 downstream from the illumination position B.

### Side Plates

The side plates 84 stand erect along the x-y plane from the bottom of the housing 72 (refer to FIG. 8) to side Y on both outer sides of the transparent belt 24, the lens pad 78, and the pressing roller 79 in direction Z. Each side plate 84 has an attachment hole, which is circular when viewed in direction Z and extends through the side plate 84 in direction Z, at a portion adjacent to the lens pad 78 in direction Z. The attachment hole is not illustrated. A bearing, which is not illustrated and whose axis extends in direction Z, is fitted into the attachment hole.

Each side plate 84 has a guide hole 87, which extends through the side plate 84 in direction Z, at a portion adjacent to the pressing roller 79 in direction Z. The guide hole 87 is so sized as to receive the shaft 34B of the pressing roller 79. The guide hole 87 is a long hole extending to form an arc when viewed in direction Z. The guide hole 87 guides the shaft 34B so that the shaft 34B moves in an arc-shaped movement locus K, described below, when the outer peripheral surface of the shaft 34B touches the hole wall of the guide hole 87.

### Support Portion

The support portion 86 includes, for example, a shaft member 92, support plates 94, and bearings 96. The shaft member 92 has a columnar shape whose axis extends in direction Z. An end portion of the shaft member 92 is inserted into and rotatably supported by a bearing, not illustrated, attached to one side plate 84. A gear, not illustrated, is attached to the shaft member 92.

The support plates 94 are disposed on the outer sides of both side plates 84 in direction Z so as to face each other while having their thickness extend in direction Z. Each support plate 94 has a through hole 97 on side Y and a through hole 98 on side −Y, which extend through the support plate 94 in direction Z. Another end portion of the shaft member 92 is fitted into and fixed to the through hole 97. Each bearing 96 is fitted into the corresponding through hole 98, which is open (whose axis extends) in direction Z.

The shaft 34B is inserted into the bearing 96 so as to be rotatable around its axis. When each support plate 94 and the corresponding bearing 96 move in an arc form around a rotation center Q of the shaft member 92, the pressing roller 79 moves in an arc form. The arc-shaped locus formed by the shaft 34B when each support plate 94 and the corresponding bearing 96 move in an arc form is referred to as a movement locus K. The movement locus K is part of an imaginary circle drawn around the rotation center Q, having a line segment connecting the rotation center of the shaft 34B to the rotation center Q of the shaft member 92 as a radius.

### Driving Portion

The driving portion 88 includes, for example, a motor 89. The motor 89 is driven by the controller 18 and rotates a gear, not illustrated, of the shaft member 92 in response to a command from the controller 18. Specifically, when the motor 89 rotates the shaft member 92, the pressing roller 79 moves along the movement locus K.

### Position of Pressing Roller

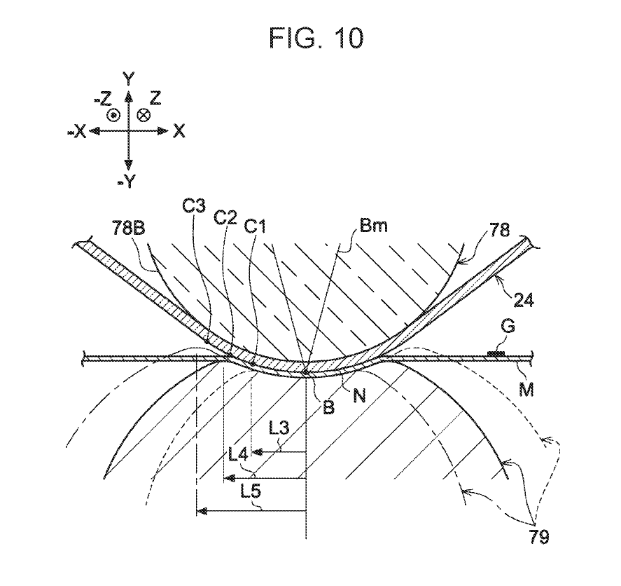

As illustrated in FIG. 10, when the nip portion N is viewed in direction Z, the position of the pressing roller 79 when, with respect to the illumination position B, the pressing roller 79 has a dimension on side X greater than the dimension on side −X is referred to as a first position. The position of the pressing roller 79 when, with respect to the illumination position B, the pressing roller 79 has a dimension on side X substantially equal to the dimension on side −X is referred to as a second position. The position of the pressing roller 79 when, with respect to the illumination position B, the pressing roller 79 has a dimension on side −X greater than the dimension on side X is referred to as a third position.

The separation position of the medium M when the pressing roller 79 is in the first position is denoted by C1. The separation position of the medium M when the pressing roller 79 is in the second position is denoted by C2. The separation position of the medium M when the pressing roller 79 is in the third position is denoted by C3. Here, L3<L4 <L5, where the path length from the illumination position B to the separation position C1 is denoted by L3, the path length from the illumination position B to the separation position C2 is denoted by L4, and the path length from the illumination position B to the separation position C3 is denoted by L5. In FIG. 10, the path lengths L3, L4, and L5 are expressed in direction X for simplicity.

At each of the separation positions C1, C2, and C3, the transparent belt 24 is wound around the lens pad 78. In other words, at each of the separation positions C1, C2, and C3 during transportation of the medium M, the transparent belt 24 is supported by the lens pad 78 on the inner side of the transparent belt 24. In this manner, in the fixing device 70, the pressing roller 79 holds the medium M between itself and the transparent belt 24 at the illumination position B. When the pressing roller 79 is moved upstream or downstream in the movement direction of the medium M with respect to the illumination position B, the path length is changed between L3, L4, and L5.

### Controller

For example, the controller 18 (refer to FIG. 9) according to the second exemplary embodiment has a setting that the second position of the pressing roller 79 is a reference position. In addition, the controller 18 has a setting that the pressing roller 79 remains at the reference position after the type of the medium M or the movement speed of the medium M is changed. In addition, the controller 18 has a setting that the position of the pressing roller 79 is changed from the second position to the third position when receiving information that the toner image G is to have high glossiness. In addition, the controller 18 has a setting that the position of the pressing roller 79 is changed from the second position to the first position when receiving information that the toner image G is to have low glossiness.

### Operation

The operation of the second exemplary embodiment is described now.

In the fixing device 70 illustrated in FIG. 8, the light source 74 is fixed to the housing 72. Unlike in the above comparative example, the illumination position B is negligibly moved in this structure. Thus, the amount of light energy fed to fix the toner image G is less likely to fall short. In the fixing device 70, the moving portion 82 is capable of changing the path length between L3, L4, and L5 (refer to FIG. 10). Thus, the fixing device 70 increases the path length to acquire an image having high glossiness, and the fixing device 70 reduces the path length to acquire an image having low glossiness. Thus, the image is allowed to have intended glossiness. In other words, the fixing device 70 enhances the glossiness of the fixed image compared to the comparative example.

The fixing device 70 also extends the path length for cooling the toner image G by moving the pressing roller 79 downstream from the illumination position B in the movement direction of the medium M. Here, the pressing roller 79 moves along the arc-shaped movement locus K. Thus, the dimension of the nip portion N in the movement direction of the medium M is substantially the same regardless of which of the first position, the second position, or the third position the pressing roller 79 is in. Specifically, extending the path length negligibly affects the length of the area over which the medium M is pressed. This structure reduces curling of the medium M compared to the structure that changes the path length by changing the position of a rotation body separate from the pressing roller 79. The curling here means a curve of the medium M. When the medium M is a continuous form, the medium M that curves after the medium M is cut into pieces is referred to as a curled medium M.

The image forming apparatus 10 (refer to FIG. 1) including the fixing device 70 acquires an image having higher glossiness than the structure including the fixing device according to the above comparative. In other words, the image forming apparatus 10 including the fixing device 70 reduces defects of fixed images (glossiness degradation).

### Third Exemplary Embodiment

A fixing device and an image forming apparatus according to a third exemplary embodiment are described now by way of example. Components and portions basically the same as those in the first or second exemplary embodiment are denoted with the same reference signs as those in the first or second exemplary embodiment and are not described.

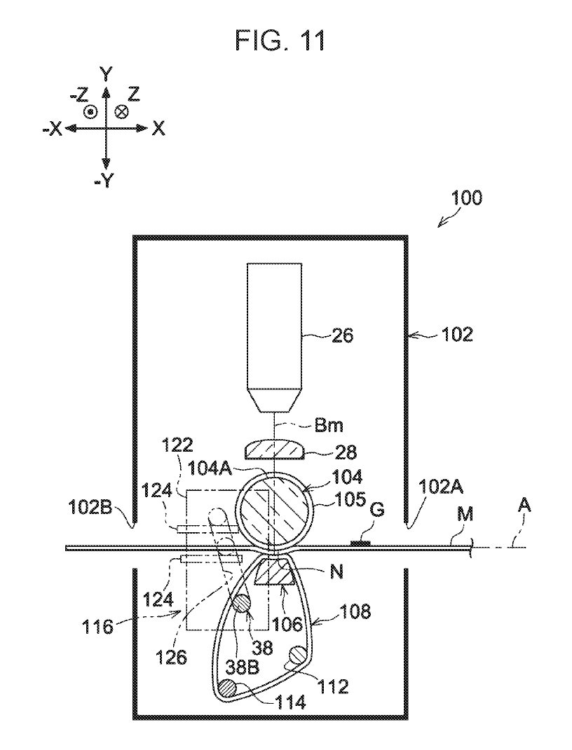

FIG. 11 illustrates a fixing device 100 according to a third exemplary embodiment. The fixing device 100 replaces the fixing device 20 (refer to FIG. 1) in the image forming apparatus 10 (refer to FIG. 1). The fixing device 100 includes, for example, a housing 102, a glass roller 104, a light source 26, a condensing lens 28, a pressing pad 106, a pressing belt 108, a support roller 112, an urging roller 114, and a moving portion 116. The housing 102 is an example of an apparatus body. The glass roller 104 is an example of a transmission member and an example of a transparent columnar member. The pressing pad 106 is an example of a pressing member. The pressing belt 108 is an example of a belt. The moving portion 116 is an example of a moving unit. In the fixing device 100, the media M are, for example, sheets of paper.

### Housing

The housing 102 is formed from a heat-resistant resin material and has a cuboid shape whose longitudinal direction extends in direction Z. The housing 102 has an inlet port 102A, allowing the medium M to enter the housing 102 therethrough, and an outlet port 102B, allowing the medium M to be discharged from the housing 102 therethrough. For example, the inlet port 102A and the outlet port 102B are arranged in direction X. The light source 26 and the condensing lens 28 are fixed to the inside of the housing 102. In this exemplary embodiment, for example, the longitudinal direction of the light source 26 is direction Z, the direction in which the laser beams Bm illuminate the toner image G is direction Y, and the direction perpendicular to direction Z and direction Y and in which the medium M is transported is direction X. The medium M is transported, for example, from side X to side −X.

### Glass Roller

The glass roller 104 is disposed on side Y of the transportation path A, along which the medium M is transported, and on side −Y of the condensing lens 28 so as to be rotatable around its axis extending in direction Z. The glass roller 104 is driven to rotate by a motor, not illustrated. The glass roller 104 is an optical member that allows the laser beams Bm, emitted from the light source 26 and condensed by the condensing lens 28, to pass therethrough and that condenses the laser beams Bm to the nip portion N, described below. For example, a coating layer 105, which includes an elastic layer and a separation layer and allows the laser beams Bm to pass therethrough, is disposed on the outer peripheral surface of the glass roller 104. In the following description, the coating layer 105 is described as being included in the glass roller 104.

A point of the outer peripheral surface of the glass roller 104 on which the laser beams Bm are incident is referred to as an incident point 104A. A point that is 180 degrees from the incident point 104A of the outer peripheral surface of the glass roller 104 is referred to as a nip portion N. The nip portion N is a portion of the outer peripheral surface of the glass roller 104 that holds the medium M between itself and the pressing belt 108, described below, to press the medium M.

### Pressing Pad

The pressing pad 106 is located adjacent to the glass roller 104 in direction Y on side −Y of the transportation path A. The pressing pad 106 has its longitudinal direction extending in direction Z. The pressing pad 106 is urged toward the glass roller 104 by a spring, not illustrated. The contact roller 38 is located on side −X of the pressing pad 106 in the movement direction of the medium M so as to be rotatable around its axis extending in direction Z.

### Pressing Belt

The pressing belt 108 is endless and formed from, for example, polyimide. The pressing belt 108 is stretched around the pressing pad 106, the contact roller 38, a support roller 112, and an urging roller 114. The support roller 112 and the urging roller 114 are described below. The pressing belt 108 forms a nip portion N, at which it presses the medium M, together with the glass roller 104 as a result of being urged toward (pressed against) the glass roller 104 by the pressing pad 106. The pressing belt 108 is driven to rotate by the rotation of the glass roller 104.

### Support Roller and Urging Roller

The support roller 112 is located on side −Y of the pressing pad 106 so as to be rotatable around its axis extending in direction Z. The urging roller 114 is located on side −Y of the contact roller 38 and side −X of the support roller 112 so as to be rotatable around its axis extending in direction Z. The urging roller 114 urges the pressing belt 108 outward using a spring, not illustrated, to provide a tension to the pressing belt 108. The urging roller 114 has its position changed in direction Y together with, for example, the movement of the contact roller 38.

### Moving Portion

The moving portion 116 is located on a side of the medium M (transportation path A) opposite to the glass roller 104. The moving portion 116 includes, for example, a contact roller 38, side plates 122, and stoppers 124. When the moving portion 116 is in the reference state, the moving portion 116 moves the contact roller 38 relative to the glass roller 104 so that the medium M touches the glass roller 104 over a larger area downstream from the illumination position B.

### Side Plates

The side plates 122 stand erect along a x-y plane from the bottom of the housing 102 to side Y on both outer sides, in direction Z, of the glass roller 104, the pressing pad 106, and the pressing belt 108. FIG. 11 illustrates part of one side plate 122. Each side plate 122 has a guide hole 126, which extends through the side plate 122 in direction Z, at a portion adjacent to the contact roller 38 in direction Z.

The guide hole 126 is so sized as to receive the shaft 38B of the contact roller 38. The guide hole 126 is an obliquely extending long hole located so that, when viewed in direction Z, an end on side Y is located on side −X of the end on side −Y. The guide hole 126 guides the shaft 38B when the outer peripheral surface of the shaft 38B touches the hole wall of the guide hole 126.

Each side plate 122 also includes guide rails, not illustrated, for holding the contact roller 38 at a second position or a third position, described below. The guide rails are located on side X and side −X of the guide hole 126 but not disposed at a portion adjacent to the guide hole 126 in direction Z. The guide rails extend in direction X.

The stoppers 124 are formed from, for example, plates. The stoppers 124 are attached to each side plate 122 as a result of being guided by the guide rails, not illustrated, to support the shaft 38B of the contact roller 38 from side −Y. In this exemplary embodiment, the position of the contact roller 38 is manually determined.

### Position of Contact Roller

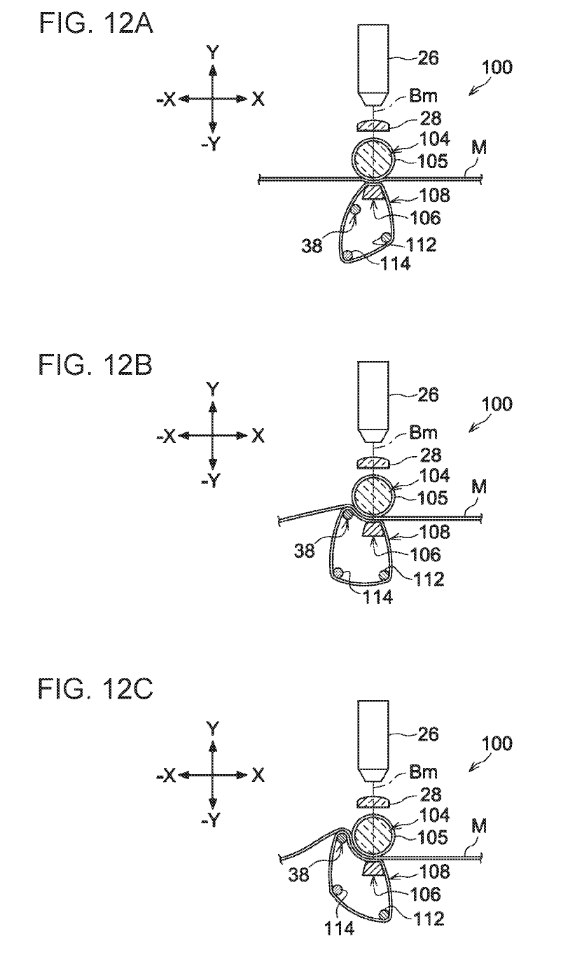

As illustrated in FIG. 12A, the position of the contact roller 38 when the contact roller 38 is on side −Y of the pressing pad 106 is referred to as a first position. As illustrated in FIG. 12B, the position of the contact roller 38 when the contact roller 38 is aligned in direction X with the bottom of the glass roller 104 in direction Y is referred to as a second position. As illustrated in FIG. 12C, the position of the contact roller 38 when the contact roller 38 is aligned in direction X with the center of the glass roller 104 in direction Y is referred to as a third position. Here, the path length from the illumination position of the laser beam Bm to the separation position of the medium M increases in order as the position of the contact roller 38 is changed to the first position, the second position, and the third position.

### Operation

The operation of the third exemplary embodiment is described below.

In the fixing device 100 illustrated in FIG. 11, the light source 26 is fixed to the housing 102. In this structure, the illumination position is negligibly changed unlike in the structure of the above comparative example. This structure thus prevents shortage of the amount of light energy fed to fix the toner image G. In the moving portion 116 of the fixing device 100, the path length from the illumination position to the separation position is rendered changeable by manually changing the position of the contact roller 38 between the first position, the second position, and the third position. The fixing device 100 increases the path length to acquire an image having high glossiness, and the fixing device 100 reduces the path length to acquire an image having low glossiness. Thus, the image is allowed to have intended glossiness. In other words, the fixing device 100 enhances the glossiness of the fixed image compared to the comparative example.

The fixing device 100 separately including the pressing pad 106 and the contact roller 38 is capable of increasing the path length from the illumination position to the separation position unlike in the structure where the contact roller 38 and the pressing pad 106 are integrated as a common unit. In other words, the medium M touches the glass roller 104 over a greater area. This structure extends the cooling time of the toner image G.

In the fixing device 100, the glass roller 104 touches the medium M. Thus, the heat of the toner image G is more easily transmitted to the glass roller 104 than in the structure that includes the transparent belt to allow the laser beams Bm to pass therethrough. This structure thus facilitates cooling of the toner image G.

In addition, in the fixing device 100, the area of the medium M from the illumination position to the separation position is supported by the pressing belt 108. This structure prevents the medium M in the sheet form from falling off between the pressing pad 106 and the contact roller 38.

The image forming apparatus 10 (refer to FIG. 1) including the fixing device 100 is capable of forming an image having higher glossiness than the structure including the fixing device according to the above comparative example. In other words, the image forming apparatus 10 including the fixing device 100 reduces defects of the fixed image (glossiness degradation).

The present invention is not limited to the above exemplary embodiments.

### First Modification Example

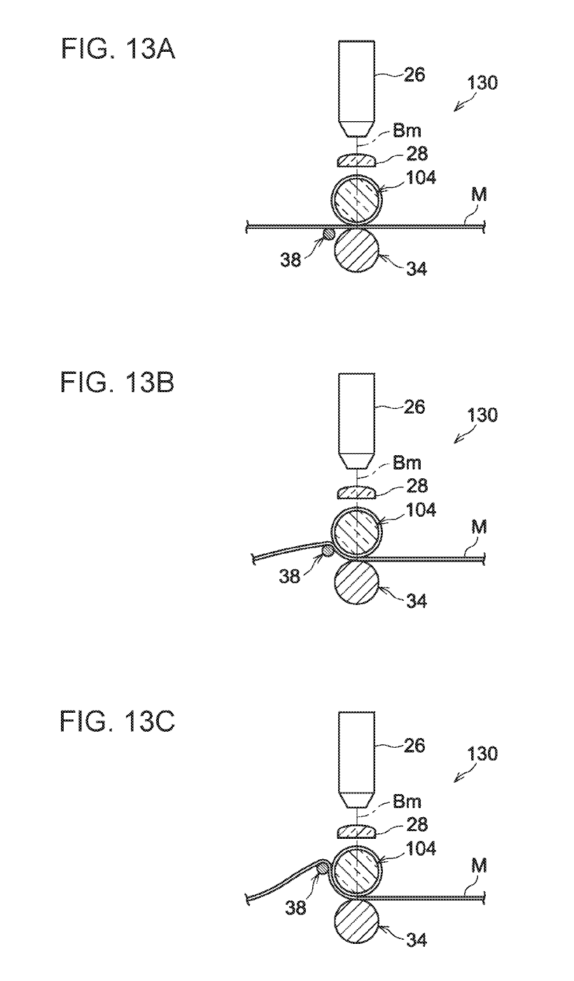

As illustrated in FIGS. 13A, 13B, and 13C, the fixing device 100 (refer to FIG. 12) according to the third exemplary embodiment may be replaced with a fixing device 130 that excludes the support roller 112 and the urging roller 114 (refer to FIG. 12) and in which the pressing pad 106 (refer to FIG. 12) is replaced with the pressing roller 34.

### Second Modification Example

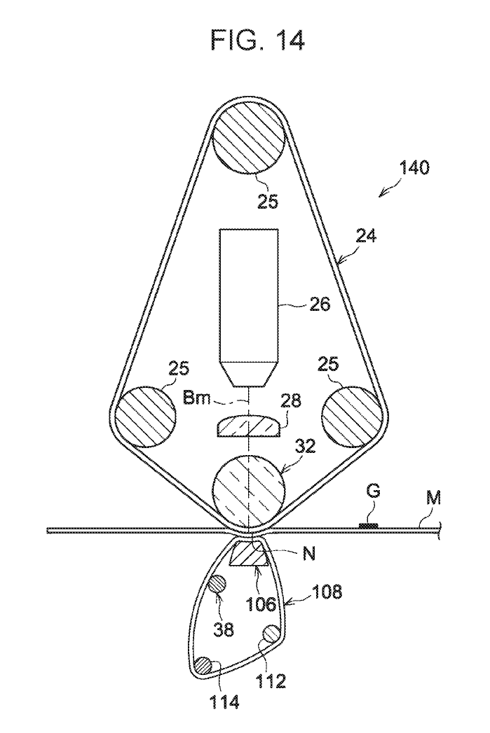

As illustrated in FIG. 14, the fixing device 20 (refer to FIG. 2) according to the first exemplary embodiment may be replaced with a fixing device 140 that excludes the pressing roller 34 (refer to FIG. 2) and instead includes a pressing pad 106, a pressing belt 108, a support roller 112, and an urging roller 114.

### Third Modification Example

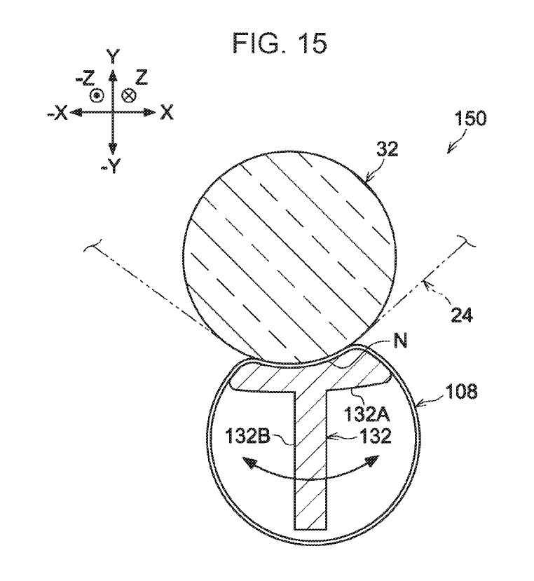

As illustrated in FIG. 15, the fixing device 140 (refer to FIG. 14) according to the second modification example may be replaced with a fixing device 150 that excludes the pressing pad 106, the contact roller 38, the support roller 112, and the urging roller 114 (refer to FIG. 14) and instead includes a pressing pad 132. A pressing pad 132 extends in, for example, direction Z and includes a contact portion 132A, which touches the inner peripheral surface of the pressing belt 108, and a plate portion 132B, which supports the contact portion 132A. The plate portion 132B is urged toward the glass roller 104 by a spring, not illustrated. A columnar shaft, not illustrated, is disposed on both end portions of the plate portion 132B in direction Z. This shaft is movable in an arc form along the guide groove in a side plate, not illustrated. In this structure including the pressing belt 108 and the pressing pad 132, the path length from the illumination position to the separation position may be manually changed while keeping the width of the nip portion N substantially unchanged.

### Other Modification Examples

Oil may be applied to the inner peripheral surface of the transparent belt 24 or the pressing belt 108. The light source 26 may be disposed on the outer side of the transparent belt 24.

Besides being solid, the transparent roller 32 or the glass roller 104 may be hollow as long as they are capable of condensing (converging) the laser beams Bm toward the nip portion N. Besides glass, the transparent roller 32 may be formed from, for example, resin such as acryl. The glass roller 104 may be replaced with a resin-made roller.

Besides stainless steel, the pressing roller 34 may be formed from aluminium or other metals. The pressing roller 34 may have its surface covered with an elastic layer or a separation layer. The pressing roller 34 may be hollow instead of solid.

Besides stainless steel, the contact roller 38 may be formed from aluminium or other metals. The contact roller 38 may have its surface covered with an elastic layer or a separation layer. The contact roller 38 may be hollow instead of solid. One or more contact rollers 38 may be provided.

In the fixing device 20, the contact roller 38 may be manually moved. In the fixing device 70, the pressing roller 34 may be manually moved. The fixing device 20 may exclude the transparent roller 32 and include multiple rollers on the inner side of the transparent belt 24 aside the optical path of the laser beams Bm.

In the fixing device 100, the contact roller 38 may be automatically moved by, for example, a solenoid. Each of the fixing devices 130, 140, and 150 may include a moving portion 36 or a moving portion 82 to automatically move the contact roller 38 or the pressing pad 132.

In the structure including a pair of transportation rollers upstream or downstream, in the movement direction of the medium M, from the glass roller 104 on which the laser beams Bm are incident from the light source 26, the path length may be changed by moving the contact roller 38.

Besides through the control panel 16, various types of information may be set on the basis of information stored in the controller 18 after being transmitted wirelessly or with wires to the controller 18 from a computer outside of the image forming apparatus 10.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a light source fixed to an apparatus body;
a transmission member that touches a developer image on a recording medium while rotating and that allows light from the light source to pass therethrough toward the developer image; and
a moving unit located on a side of the recording medium opposite to the transmission member, the moving unit increasing, when moved relative to the transmission member, an area of the recording medium over which the recording medium touches the transmission member downstream from an illumination position, at which the developer image on the recording medium is irradiated with light.

2. The fixing device according to claim 1, further comprising:
a pressing member that holds the recording medium between the pressing member and the transmission member to press the recording medium at the illumination position,
wherein the moving unit includes a moving member that is disposed downstream from the pressing member in a movement direction of the recording medium and that is moved relative to the transmission member.

3. The fixing device according to claim 2,
wherein the transmission member is an endless transparent belt,
wherein a contact member is disposed on an inner side of the transparent belt, the contact member allowing light to pass therethrough and touching an inner peripheral surface of the transparent belt at the illumination position of light, and
wherein the moving member holds the transparent belt and the recording medium between the moving member and the contact member.

4. The fixing device according to claim 2, wherein the transmission member is a transparent columnar member.

5. The fixing device according to claim 2, further comprising an endless belt stretched around the pressing member and the moving member.

6. The fixing device according to claim 1,
wherein the moving unit includes a changing member that holds the recording medium between the changing member and the transmission member at the illumination position, the moving unit changing, when moved upstream or downstream from the illumination position in a movement direction of the recording medium, an area of the recording medium over which the recording medium touches the transmission member downstream from an illumination position.

7. An image forming apparatus, comprising:
a forming unit that forms a developer image on a recording medium;
the fixing device according to claim 1 that fixes the developer image formed by the forming unit onto the recording medium; and
a controller that controls movement of the moving unit so that the recording medium touches the transmission member over a wider area downstream from the illumination position than in a case where the developer image subjected fixing is to have low glossiness or in a case where the recording medium is to be moved at a low movement speed.
